(19) United States
(12) Patent Application Publication
(10) Pub. No.: US 2010/0158276 A1
(43) Pub. Date: Jun. 24, 2010

(54) DIGITAL MICROPHONE

(75) Inventors: Li-Te Wu, Taipei (TW); Chun-Chun Huang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/343,772

(22) Filed: Dec. 24, 2008

(51) Int. Cl. H04R 3/00

(52) U.S. Cl. 381/111

(57) ABSTRACT

A digital microphone is provided, comprising a transducer for converting sound pressure into an analog electrical signal, an analog-to-digital converter for converting the analog electrical signal into a digital signal according to a clock signal, and a clock buffer circuit coupled between the analog-to-digital converter and a clock source for deducting a high frequency component from the clock signal received from the clock source.

### BACKGROUND OF THE INVENTION

1. Field of the Invention

The present invention relates to digital microphones, and in particular relates to digital electret condenser microphones (ECMs).

2. Description of the Related Art

Electret condenser microphones (ECM) are widely used in portable devices due to its simple structure, good performance and small size.

An analog ECM is described below. The analog ECM at least comprises a transducer for converting sound pressures into electrical signals. The transducer at least comprises an electret diaphragm and a back-plate. The electret diaphragm and the back-plate are separated from each other by a spacer having a thickness do. Meanwhile, the electret diaphragm and the back-plate are arranged in the form of a capacitor. The electret diaphragm is pre-charged with a charge Q and has a built in electric field. The back-plate is usually made in a plastic ring, and is coupled to a ground. When the electret diaphragm is vibrated by the sound pressure from an outside source, the distance between the diaphragm and the back-plate are changed accordingly. Suppose that the measure of the area A of the electret diaphragm and the dielectric constantε₀ of the material of the spacer are given, the capacitance C of the capacitor can be obtained by the formula: C=ε₀A/d₀. Further, the voltage V of the capacitor can be obtained by the formula: V=Q/C. When the initial voltage V₀ on the diaphragm is given, the voltage variation □V and the distance variation δd have the relation as follows:

$$Δ V = \frac{δ d}{{d}_{0}} {V}_{0} .$$

Since the voltage difference □V on the diaphragm is proportional to the distance difference δd caused by the sound pressure, those skilled in the art can acquire the information of the sound by measuring the voltage variation □V.

Meanwhile, digital ECMs have become more and more popular. FIG. 1 is a schematic diagram of a conventional digital ECM. The digital ECM 100 comprises a transducer 101, a preamplifier 102 and an analog-to-digital converter (ADC) 103. The transducer 101 is configured to convert a sound pressure into an analog voltage signal as described above. The preamplifier 102 with high input impedance and low output impedance is configured to amplify the analog voltage signal. The ADC 103 is configured to convert the analog voltage signal into digital signal DATA and output the digital signal DATA to an outside source. In addition, the digital ECM 100 further comprises a metal cabinet 104 for shielding the transducer 101, the preamplifier 102 and the ADC 103 from radio frequency (RF) radiation interference.

The digital ECM 100 is coupled between a power source VDD and the ground GND to obtain energy from an outside source. Further, those skilled in the art can understand that since the presence of the ADC 103 makes the ECM 100 a digital device, the ADC 103 has to be provided with the clock signal CLK to sample the analog voltage signal. However, unfortunately, there is no ideal clock signal. Instead, there is an uncertain amount of clock signal variations from a clock cycle to clock a cycle. The variation may have a number of sources, and is generally referred to as jitter. The ADC 103 suffering from jitters may seriously affect sampling processes, thus unnecessary distortions in the digital signals DATA may occur.

FIG. 2a shows the waveform of an ideal clock signal. In each cycle of the ideal clock signal, the high and low levels defined by voltages are clear, and thus the rising and falling edges are steep. Additionally, each period of the cycles signal is the same (for example, 400 nsec). FIG. 2b shows the waveform of a clock signal with phase noise. Due to the natural imperfection of the clock source, the phases in the clock signal may be uncertainly shifted in FIG. 2b, and each period of the cycles may vary (for example, between 400±X nsec) from time to time. In this case, a specification will be defined for manufacturers to limit the variation (for example, to limit X nsec to be lower than 1 nsec). FIG. 2c shows the waveform of a rude clock signal. Since the clock signals are usually affected by the RF radiation interference when they are transmitted through media such as copper wires, ripples occur not only on the high and low levels but also on the rising and falling edges in each cycle of the clock signals. Unfortunately, these ripples occurring on the rising or falling edges of the clock signal often significantly change during different periods, and seriously influence the precision of the digital ECMs.

### BRIEF SUMMARY OF INVENTION

A digital microphone is provided, comprising a transducer for converting sound pressure into an analog electrical signal, an analog-to-digital converter for converting the analog electrical signal into a digital signal according to a clock signal, and a clock buffer circuit coupled between the analog-to-digital converter and a clock source for deducting a high frequency component from the clock signal received from the clock source.

Another digital microphone is provided, comprising a transducer for converting sound pressure into an analog electrical signal, an analog-to-digital converter for converting the analog electrical signal into a digital signal according to a clock signal, and a clock buffer circuit coupled between the analog-to-digital converter and a clock source for deducting a high frequency component from the clock signal received from the clock source and a metal cabinet covering the transducer, the analog-to-digital converter and the clock buffer circuit, wherein the clock source is outside of the metal cabinet.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a schematic diagram of a conventional digital ECM;

FIG. 2a shows the waveform of an ideal clock signal;

FIG. 2b shows the waveform of a clock signal with phase noise;

FIG. 2c shows the waveform of a rude clock signal;

FIG. 3 is a schematic diagram of the digital electret condenser microphone (ECM) according to the present invention;

FIG. 4 shows a schematic diagram of a typical first order RC filter.

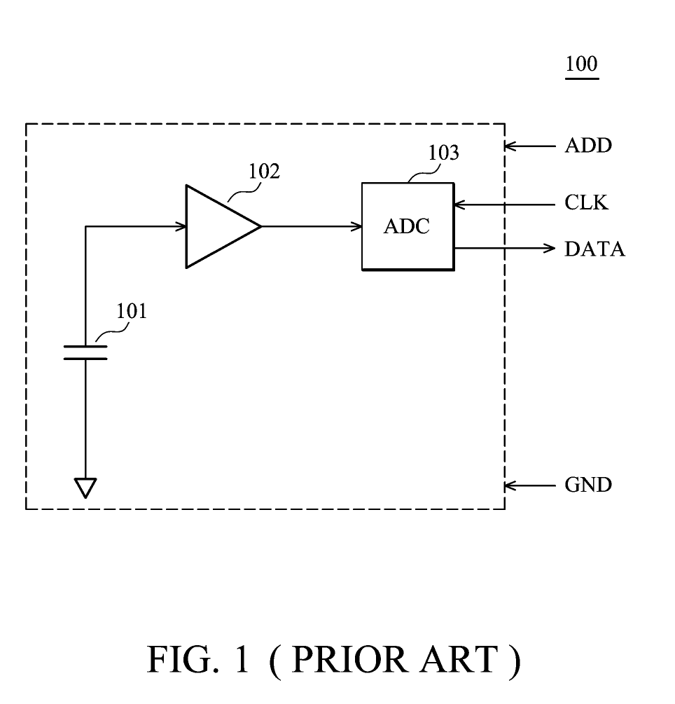

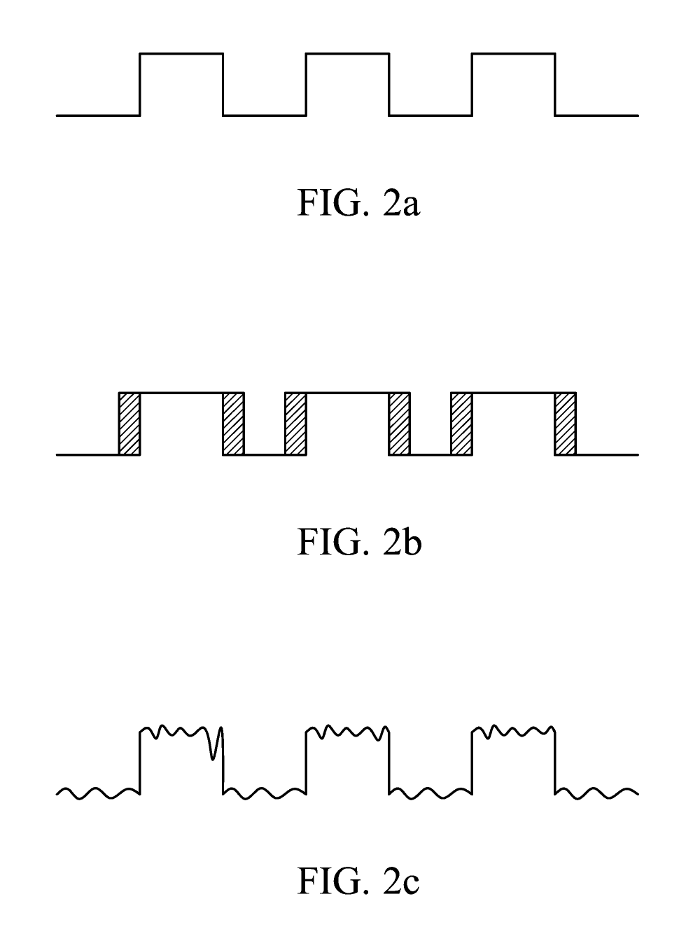

### DETAILED DESCRIPTION OF INVENTION

The following description is of the best contemplated mode of carrying out the invention. This description is made for the purpose of illustrating the general principles of the invention and should not be taken in a limiting sense. The scope of the invention is best determined by reference to the appended claims.

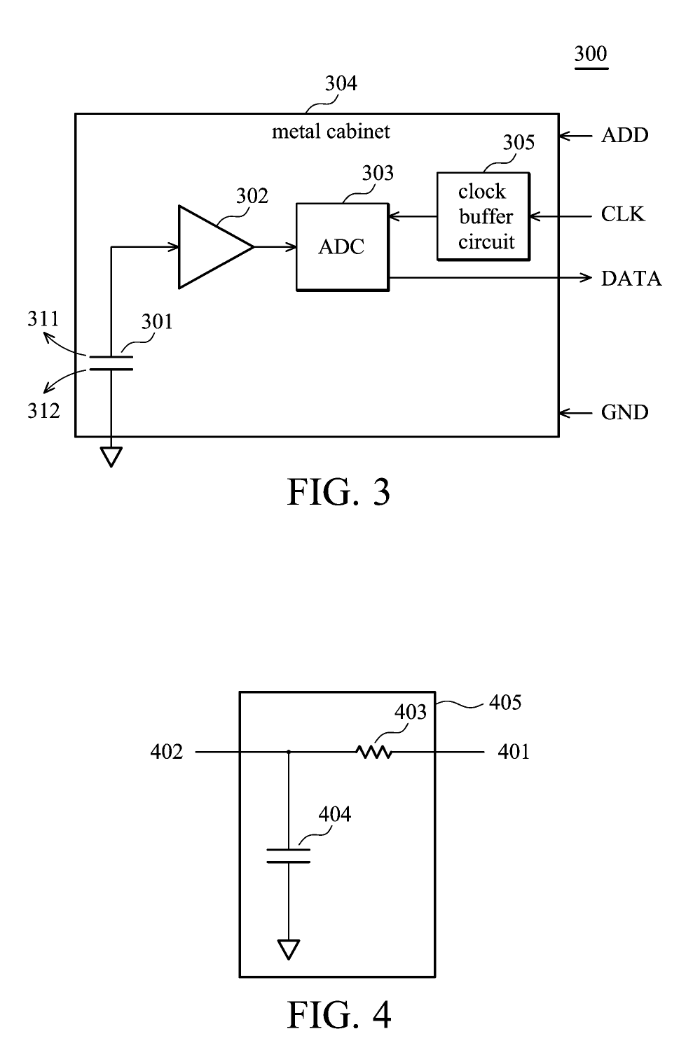

FIG. 3 is a schematic diagram of the digital electret condenser microphone (ECM) according to the present invention. The digital ECM 300 comprises a transducer 301, a preamplifier 302, an analog-to-digital converter (ADC) 303 and a clock buffer circuit 305.

The transducer 301 comprises an electret diaphragm 311 and a back-plate 312. The electret diaphragm 311 is pre-charged with charge Q, the back-plate is coupled to a ground, and the distance between the electret diaphragm 311 and the back-plate 312 can be changed according to the sound pressure. As discussed above in the prior art, the transducer 301 can be used to convert the sound pressure into an analog electrical signal. The preamplifier 302 is coupled between the transducer 301 and the ADC 303, and is used to amplify the analog electrical signal. The ADC 303 is coupled to the preamplifier 302 and is used to further convert the analog electrical signal into a digital signal DATA according to a clock signal CLK from a clock source (not shown) and then output the digital signal DATA to an outside source.

In the present invention, the clock buffer circuit 305 is disposed in the digital ECM 300. The clock buffer circuit 305 is coupled between the ADC 303 and the clock source and is used to deduct the high frequency component from the clock signal CLK. For example, the clock buffer circuit 305 is a low pass filter. The low pass filter can be embodied in many modes, wherein those skilled in the art will appreciate that the invention is not limited in this regard.

FIG. 4 shows a schematic diagram of a typical first order RC filter. The low pass filter (LPF) 405 comprises an input terminal 401, an output terminal 402, a resistor 403 and a capacitor 404. The input terminal 401 is coupled to the clock source to receive the rude clock signals, while the output terminal 402 is coupled to the ADC 303 to output high-frequency-filtered clock signals. The resistor is coupled between the input terminal 401 and the output terminal 402, while the capacitor 404 is coupled between the output terminal 402 and a ground. The high frequency components in the clock signals will be filtered out by the effect of the combination of the resistor and the capacitor as is well known in the art. For example, to protect the clock signal in the digital ECM 300(which has frequency from about 1 MHz to 4 MHz) from RF interference such as GSM interference (having frequency of about 900 MHz/1800 MHz/1900 MHz), Bluetooth interference (having frequency about 2.4 GHz) or WLAN interference (having frequency about 2.4 G/5G), the cutoff frequency can be specified at about 10 MHz.

Moreover, the digital ECM 300 further comprises a metal cabinet 304. The metal cabinet 304 covers the transducer 301, the preamplifier 302, the ADC 303 and the clock buffer circuit 305. The metal cabinet 304 separates the above components from the clock source outside of the metal cabinet 304. Meanwhile, due to the shield effect of the metal material, the components in the ECM 300 will be isolated from electromagnetic interferences.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A digital microphone, comprising:
a transducer for converting sound pressure into an analog electrical signal;
an analog-to-digital converter for converting the analog electrical signal into a digital signal according to a clock signal;
a clock buffer circuit coupled between the analog-to-digital converter and a clock source for deducting a high frequency component from the clock signal received from the clock source.

2. The digital microphone as claimed in claim 1 further comprises a preamplifier coupled between the transducer and the analog-to digital converter for amplifying the analog electrical signal.

3. The digital microphone as claimed in claim 1, wherein the clock buffer circuit is a low pass filter.

4. The digital microphone as claimed in claim 1, wherein the clock buffer circuit comprises a resistor coupled between an input and an output of the clock buffer circuit and a capacitor coupled between the output of the clock circuit and a ground.

5. The digital microphone as claimed in claim 1, wherein the transducer comprises a charged diaphragm and a back-plate in the form of a capacitor, and wherein the distance between the charged diaphragm and the back-plate is changed according to the sound pressure.

6. A digital microphone, comprising:
a transducer for converting sound pressure into an analog electrical signal;
an analog-to-digital converter for converting the analog electrical signal into a digital signal according to a clock signal;
a clock buffer circuit coupled between the analog-to-digital converter and a clock source for deducting a high frequency component from the clock signal received from the clock source; and
a metal cabinet covering the transducer, the analog-to-digital converter and the clock buffer circuit, wherein the clock source is outside of the metal cabinet.

7. The digital microphone as claimed in claim 6 further comprises a preamplifier coupled between the transducer and the analog-to digital converter for amplifying the analog electrical signal.

8. The digital microphone as claimed in claim 6, wherein the clock buffer circuit is a low pass filter.

9. The digital microphone as claimed in claim 6, wherein the clock buffer circuit comprises a resistor coupled between an input and an output of the clock buffer circuit and a capacitor coupled between the output of the clock circuit and a ground.

10. The digital microphone as claimed in claim 6, wherein the transducer comprises a charged diaphragm and a back-plate in the form of a capacitor, and wherein the distance between the charged diaphragm and the back-plate is changed according to the sound pressure.
